(19) United States
(12) Patent Application Publication
(10) Pub. No.: US 2024/0364034 A1
(43) Pub. Date: Oct. 31, 2024

(54) Connector

(71) Applicant: Tyco Electronics (Shanghai) Co., Ltd., Shanghai (CN)

(72) Inventors: Hengkang Wu, Dongguan (CN); Xinjie (David) Zhang, Shanghai (CN)

(73) Assignee: Tyco Electronics (Shanghai) Co., Ltd., Shanghai (CN)

(21) Appl. No.: 18/647,460

(22) Filed: Apr. 26, 2024

(30) Foreign Application Priority Data
Apr. 28, 2023 (CN) 202321026064.X

(51) Int. Cl. H01R 13/04; H01R 12/73; H01R 13/42; H01R 13/514; H01R 13/646

(52) U.S. Cl. CPC H01R 13/04; H01R 12/73; H01R 13/42; H01R 13/514; H01R 13/646

(57) ABSTRACT

A connector comprises a first terminal, a second terminal, and a retaining body. The first terminal is arranged in the housing and has a first connection end adapted to electrically contact a mating terminal in a mating connector and a first contact end adapted to electrically contact a board card. The second terminal is provided in the housing and has a second connection end adapted to electrically connect with a cable and a second contact end for electrical contact with the board card. The first connection end of the first terminal is retained on the retaining body. A surface of one side of the first connection end of the first terminal is exposed from the retaining body to form a gold finger or contact adapted to electrically contact the mating terminal. The retaining body forms a plug adapted to be inserted into the mating connector.

### CROSS-REFERENCE TO RELATED APPLICATION

This application claims the benefit of Chinese Patent Application No. CN202321026064.X filed on Apr. 28, 2023, in the State Intellectual Property Office of China, the whole disclosure of which is incorporated herein by reference.

### FIELD OF THE INVENTION

The present invention relates to a connector, and in particular, to a multifunctional connector with a high-speed signal terminal and a low-speed signal terminal.

### BACKGROUND

In the prior art, for multifunctional connectors with low-speed signal terminals and high-speed signal terminals, the low-speed signal terminals usually need to be connected to an associated circuit board through separate electronic wires to achieve electrical connection therebetween. The high-speed signal terminal(s) of this multifunctional connector is usually connected to a high-speed cable and transmits high-speed differential signals through the high-speed cable. In the prior art, the application range of connectors is limited due to the need for low-speed signal terminals to be connected to the circuit board through electronic wires.

### SUMMARY

According to one embodiment of the present disclosure, a connector comprises a first terminal, a second terminal, and a retaining body. The first terminal is provided in the housing and has a first connection end adapted to electrically contact a mating terminal in a mating connector and a first contact end for electrically contacting a board card or circuit board. The second terminal is provided in the housing and has a second connection end for electrically connecting with a cable and a second contact end for electrically contacting the board card. The first connection end of the first terminal is retained on the retaining body. A surface of one side of the first connection end of the first terminal is exposed from the retaining body to form a gold contact or finger adapted to electrically contact the mating terminal. The retaining body forms a plug suitable for insertion into the mating connector.

### BRIEF DESCRIPTION OF THE DRAWINGS

The invention will now be described by way of example with reference to the accompanying Figures, of which:

FIG. 1 shows an illustrative perspective view of a connector according to an exemplary embodiment of the present invention;

FIG. 2 shows an illustrative perspective view of a connector according to an exemplary embodiment of the present invention, wherein the housing, second holding body, and external injection molded body are not shown;

FIG. 3 shows an illustrative perspective view of a connector according to an exemplary embodiment of the present invention, wherein the housing and external injection molded body are not shown;

FIG. 4 shows an illustrative perspective view of a connector according to an exemplary embodiment of the present invention, wherein an external injection molded body is not shown;

FIG. 5 shows an illustrative perspective view of a connector according to another exemplary embodiment of the present invention;

FIG. 6 shows an illustrative perspective view of a connector according to another exemplary embodiment of the present invention, wherein the housing and external injection molded body are not shown;

FIG. 7 shows an illustrative exploded view of a connector according to another exemplary embodiment of the present invention, wherein the housing, second holding body, and external injection body are not shown; and

FIG. 8 shows an illustrative perspective view of a connector according to an exemplary embodiment of the present invention, wherein an external injection molded body is not shown.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a connector comprises a housing and a first terminal arranged in the housing. The first terminal has a first connection end for electrical contact with a mating terminal in a mating connector and a first contact end for electrical contact with a board card. A second terminal is arranged in the housing and has a second connection end for electrical connection with a cable and a second contact end for electrical contact with the board card. The connector further includes retaining body on which the first connection end of the first terminal is retained. A surface of one side of the first connection end of the first terminal is exposed from the retaining body to form a contact or finger suitable for electrical contact with the mating terminal. The retaining body forms a plug suitable for insertion into the mating connector.

According to another embodiment a connector includes a housing, and a circuit board formed with a first golden finger (or conductive contact) and a second golden finger (or conductive contact). A first terminal of the connector is provided in the housing and has a first connection end for electrical contact with the first golden finger and a first contact end for electrical contact with a board card. A second terminal of the connector is provided in the housing and has a second connection end for electrical connection with a cable and a second contact end for electrical contact with the board card. The circuit board has a plug portion suitable for insertion into a mating connector. The second golden finger is formed on the surface of the plug portion for electrical contact with a mating terminal in the mating connector.

### First Embodiment

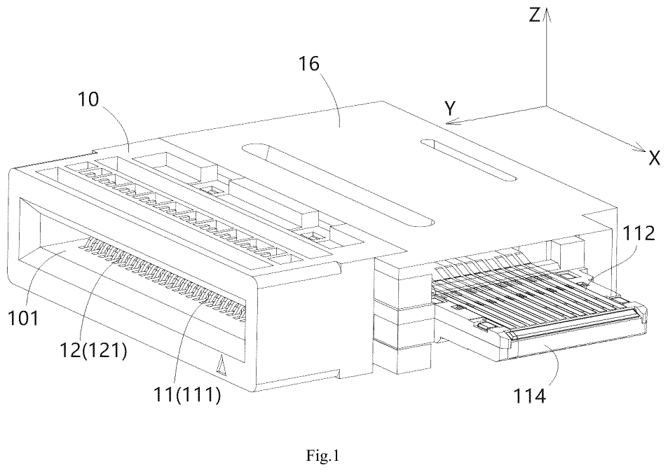

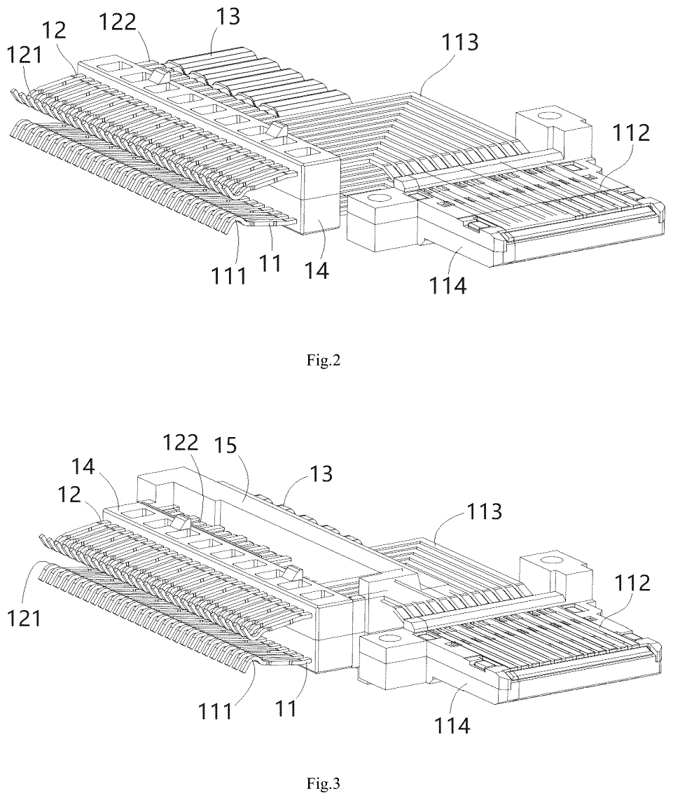

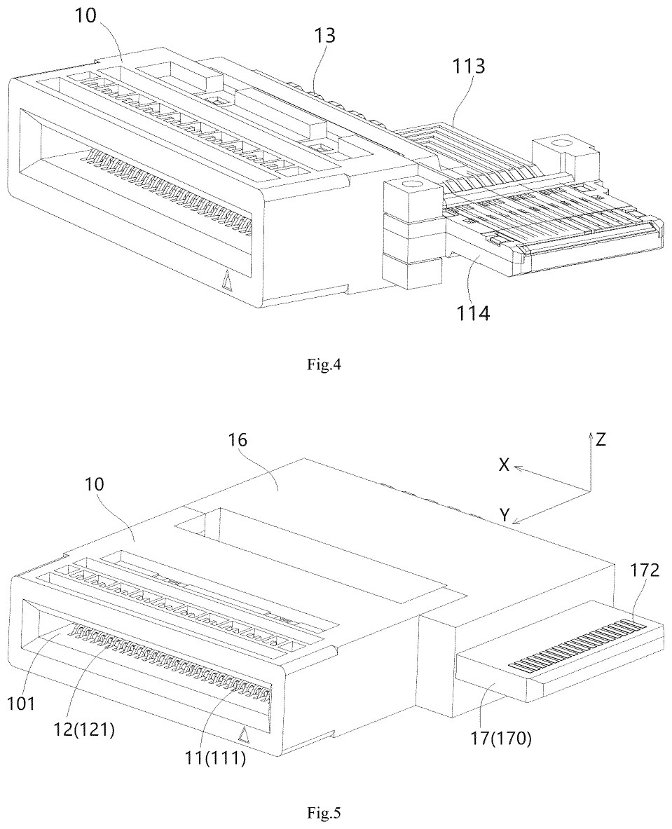

FIGS. 1-4 illustrate a first embodiment of the present invention. Specifically, FIG. 1 shows an illustrative perspective view of a connector according to an exemplary embodiment of the present invention. FIG. 2 shows an illustrative perspective view of a connector according to an exemplary embodiment of the present invention, wherein a housing, a second holding body, and an external injection molded body are not shown. FIG. 3 shows an illustrative perspective view of a connector according to an exemplary embodiment of the present invention, where the housing and the external injection molded body are not shown. FIG. 4 shows an illustrative perspective view of a connector according to an exemplary embodiment of the present invention, wherein the external injection molded body is not shown.

As shown in FIGS. 1-4, in an exemplary embodiment of the present invention, a connector is disclosed. The connector mainly includes a housing 10, a first terminal 11, a second terminal 12, and a retaining body 114. The first terminal 11 is provided in the housing 10, which has a first connection end 112 for electrical contact with a mating terminal (not shown) in a mating connector (not shown) and a first contact end 111 for electrical contact with a first gold finger on aboard card (not shown). The second terminal 12 is provided in the housing 10, which has a second connection end 122 for electrical connection with a cable 13 and a second contact end 121 for electrical contact with a second golden finger on the aforementioned board card. The first connection end 112 of the first terminal 11 and the retaining body 114 are located outside the housing 10, and the first connection end 112 of the first terminal 11 is held on the retaining body 114. The surface of one side of the first connection end 112 of the first terminal 11 is exposed out of the retaining body 114, forming a gold finger suitable for electrical contact with the mating terminal. The retaining body 114 forms a plug suitable for insertion into the mating connector. Therefore, the connector of the present invention can be quickly mated and connected with the mating connector through the gold fingers on the plug. In the illustrated embodiments, the retaining body 114 can be an injection molded part directly formed on the first connection end 112 of the first terminal 11 through an embedded injection molding process. In this way, manufacturing costs can be reduced.

The housing 10 has opposite front and rear sides in its longitudinal direction Y. A slot 101 for inserting the board card is formed on the front side of the housing 10. The first contact end 111 of the first terminal 11 and the second contact end 121 of the second terminal 12 are located in slot 101 to make electrical contact with the board card inserted into slot 101.

The connector further comprises a cable 13. The core wire of the cable 13 is electrically connected to the second connection end 122 of the second terminal 12. For example, the core wire of cable 13 can be soldered or crimped to the second connection end 122 of the second terminal 12.

The connector further includes multiple first terminals 11, which are arranged in an upper row and a lower row. The upper row of first terminals 11 and the lower row of first terminals 11 are opposite in the height direction Z of the housing 10 and close to one side of the housing 10 in a transverse direction X of the housing 10. The connector also includes multiple second terminals 12. The second terminals 12 are arranged in an upper row and a lower row. The upper row of second terminals 12 and the lower row of second terminals 12 are opposite in the height direction Z of the housing 10 and close to the other side of the housing 10 in the transverse direction X of the housing 10. The first contact ends 111 of the upper row of first terminals 11 and the second contact ends 121 of the upper row of second terminals 12 are arranged in a row uniformly spaced along the transverse direction X of the housing 10. The first contact ends 111 of the lower row of first terminals 11 and the second contact ends 121 of the lower row of second terminals 12 are arranged in a row evenly spaced along the transverse direction X of the housing 10.

The first connection ends 112 of the upper row of first terminals 11 are located outside the housing 10 and arranged along the longitudinal direction Y of the housing 10. The first connection ends 112 of the lower row of first terminals 11 are located outside the housing 10 and arranged along the longitudinal direction Y of the housing 10. The second connection ends 122 of the upper row of second terminals 12 are located inside the housing 10 and arranged along the transverse direction X of the housing 10. The second connection ends 122 of the lower row of second terminals 12 are located inside the housing 10 and arranged along the transverse direction X of the housing 10.

In the illustrated embodiments, the connector further comprises a first holding body 14. The first holding body 14 holds the first terminals 11 and the second terminals 12 together, so that the first terminals 11 and the second terminals 12 can be installed together in the housing 10. In the illustrated embodiment, the first holding body 14 is an injection molded part directly formed on the first terminals 11 and the second terminals 12 through embedded injection molding process.

The first terminal 11 also has a connection part 113. The connection part 113 is connected between the first contact end 111 and the first connection end 112. The connection part 113 of the first terminal 11 extends out of the housing 10 and is perpendicularly bent towards one transverse side of the housing 10 relative to the longitudinal direction Y of the housing 10.

The connector further includes a second holding body 15 adapted to hold the connection part 113 of the first terminal 11, the second connection end 122 of the second terminal 12, and one end of the cable 13 together, so that the first terminal 11, the second terminal 12, and the cable 13 can be installed together in the housing 10. In the illustrated embodiment, the second holding body 15 is an injection molded part directly formed on the first terminal 11, the second terminal 12, and the cable 13 through embedded injection molding process. The connector further comprises an external injection molded body 16, which is formed on the rear side of the housing 10 for combining the second holding body 15 and the retaining body 114 to the rear side of the housing 10 and wrapping the connection part 113 of the first terminal 11.

In the illustrated embodiments, the first terminal 11 includes a first signal terminal (e.g., a low-speed signal terminal). The second terminal 12 includes a second signal terminal (e.g., a high-speed differential signal terminal). The signal transmission rate of the first signal terminal is lower than that of the second signal terminal.

### Second Embodiment

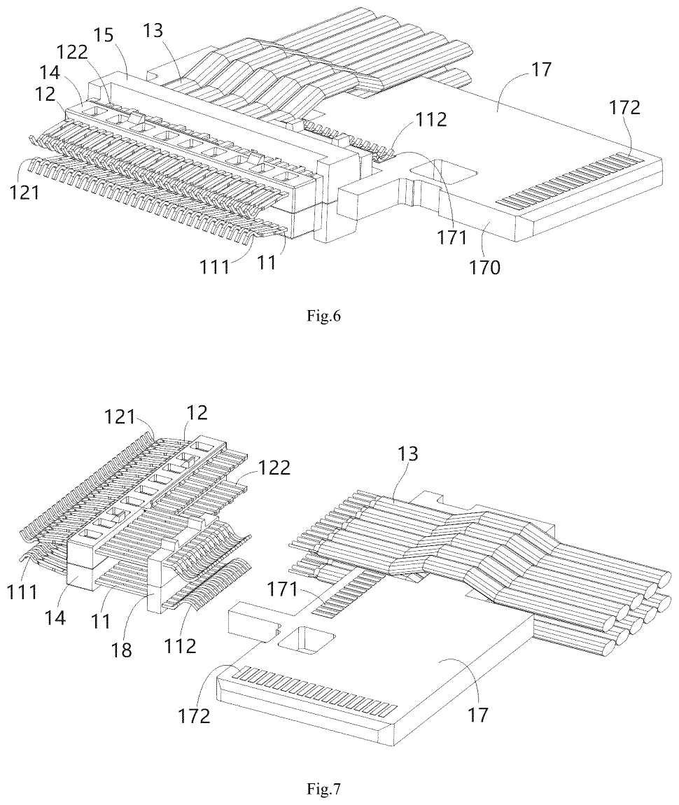

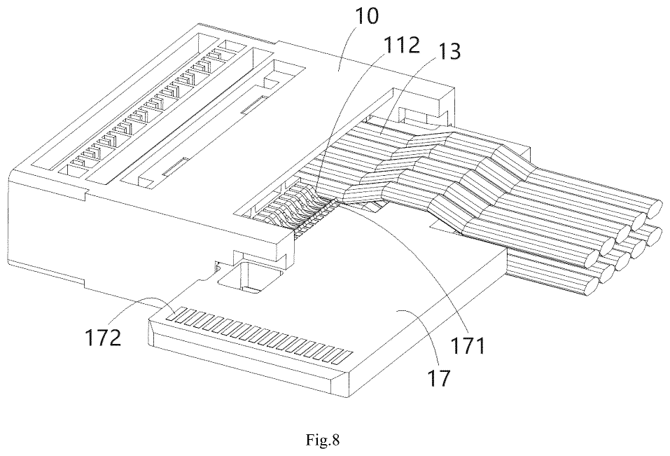

FIGS. 5-8 show a second embodiment of the present invention. Specifically, FIG. 5 shows an illustrative perspective view of a connector according to another exemplary embodiment of the present invention. FIG. 6 shows an illustrative perspective view of a connector according to another exemplary embodiment of the present invention, where the housing and the external injection molded body are not shown. FIG. 7 shows an illustrative exploded view of a connector according to another exemplary embodiment of the present invention, wherein the housing, second holding body, and external injection molded body are not shown. FIG. 8 shows an illustrative perspective view of a connector according to an exemplary embodiment of the present invention, wherein the external injection molded body is not shown.

As shown in FIGS. 5-8, in an exemplary embodiment of the present invention, a connector is disclosed. The connector includes a housing 10, a circuit board 17, a first terminal 11, and a second terminal 12. The circuit board 17 is formed with a first gold finger 171 and a second gold finger 172. The first terminal 11 is arranged in the housing 10, and has a first connection end 112 for electrical contact with the first golden finger 171 and a first contact end 111 for electrical contact with a board card (not shown). The second terminal 12 is provided in the housing 10, and has a second connection end 122 for electrical connection with a cable 13 and a second contact end 121 for electrical contact with the aforementioned board card. In the illustrated embodiment, the circuit board 17 has a plug portion 170 suitable for insertion into a mating connector (not shown), and the second golden finger 172 is formed on the surface of the plug portion 170 for electrical contact with a mating terminal (not shown) in the mating connector.

The housing 10 has opposite front and rear sides in its longitudinal direction Y. A slot 101 for inserting the board card is formed on the front side of the housing 10. The first contact end 111 of the first terminal 11 and the second contact end 121 of the second terminal 12 are located in the slot 101 to make electrical contact with the board card inserted into the slot 101.

The connector further comprises a cable 13. A core wire of the cable 13 is electrically connected to the second connection end 122 of the second terminal 12.

The connector includes multiple first terminals 11, which are arranged in an upper row and a lower row. The upper row of first terminals 11 and the lower row of first terminals 11 are opposite in the height direction Z of the housing 10 and close to one side of the housing 10 in a transverse direction X of the housing 10. The connector includes multiple second terminals 12, which are arranged in an upper row and a lower row. The upper row of second terminals 12 and the lower of second terminals 12 are opposite in the height direction Z of the housing 10 and close to the other side of the housing 10 in the transverse direction X of the housing 10.

The first contact ends 111 of the upper row of first terminals 11 and the second contact ends 121 of the upper row of second terminals 12 are arranged in a row uniformly spaced along the transverse direction X of the housing 10. The first contact ends 111 of the lower row of first terminals 11 and the second contact ends 121 of the lower row of second terminals 12 are arranged in a row evenly spaced along the transverse direction X of the housing 10.

The connector further includes multiple cables 13, which are arranged in an upper row and a lower row. The upper row of cables 13 and the lower row of cables 13 are opposite in the height direction Z of the housing 10. A portion of circuit board 17 is inserted between the upper row of cables 13 and the lower row of cables 13, to separate the upper row of cables 13 from the lower row of cables 13.

The first connection end 112 of the first terminal 11 is a curved elastic end. One side of the circuit board 17 is inserted between the first connection ends 112 of the upper row of first terminals 11 and the first connection ends 112 of the lower row of first terminals 11. A row of first golden fingers 171 are formed on each of the front surface and the back surface of one side of the circuit board 17. The row of first golden fingers 171 on the front surface of the circuit board 17 are in electrical contact with the first connection ends 112 of the upper row of first terminals 11, and the row of first golden fingers 171 on the back surface of the circuit board 17 are in electrical contact with the first connection ends 112 of the lower row of first terminals 11.

The first connection ends 112 of the upper row of first terminals 11 are located outside the housing 10 and arranged along the transverse direction X of the housing 10. The first connection ends 112 of the lower row of first terminals 11 are located outside the housing 10 and arranged along the transverse direction X of the housing 10. The second connection ends 122 of the upper row of second terminals 12 are located inside the housing 10 and arranged along the transverse direction X of the housing 10. The second connection ends 122 of the lower row of second terminals 12 are located inside the housing 10 and arranged along the transverse direction X of the housing 10.

A row of second golden fingers 172 are formed on each of the front surface and the back surface of the plug portion 170 of the circuit board 17. The first golden finger 171 on one side of the circuit board 17 extends along the longitudinal direction Y of the housing 10, and the second golden finger 172 on the plug portion 170 of the circuit board 17 extends along the transverse direction X of the housing 10.

The connector further comprises a first holding body 14. The first holding body 14 is adapted to hold the first terminal 11 and the second terminal 12 together, so that the first terminal 11 and the second terminal 12 can be installed together in the housing 10. In the illustrated embodiment, the first holding body 14 is an injection molded part directly formed on the first terminal 11 and the second terminal 12 through embedded injection molding process.

The connector further comprises a second holding body 15 holding the first terminal 11, the second terminal 12, and the cable 13 together, so that the first terminal 11, the second terminal 12, and the cable 13 can be installed together in the housing 10. In the illustrated embodiment, the second holding body 15 is an injection molded part directly formed on the first terminal 11, the second terminal 12, and the cable 13 through embedded injection molding process.

The connector further comprises a third holding body 18 holding multiple first terminals 11 together. The second holding body 15 is located between the first holding body 14 and the third holding body 18, and the third holding body 18 is close to the first connection end 112 of the first terminal 11. In the illustrated embodiment, the third holding body 18 is an injection molded part directly formed on the first terminals 11 through embedded injection molding process.

In the illustrated embodiments, the connector further comprises an external injection molded body 16. The external injection molded body 16 is formed on the rear side of the housing 10 for bonding the circuit board 17 to the rear side of the housing 10 and wrapping the first connection ends 112 of the first terminals 11.

The first terminal 11 includes a first signal terminal (e.g., a regular low-speed signal terminal). The second terminal 12 includes a second signal terminal (e.g., a high-speed differential signal terminal). A signal transmission rate of the first signal terminal is lower than that of the second signal terminal.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
a housing;
a first terminal arranged in the housing and having a first connection end adapted to electrically contact a mating terminal in a mating connector, and a first contact end adapted to electrically contact a board card;
a second terminal arranged in the housing and having a second connection end adapted to electrically connect to a cable, and a second contact end adapted to electrically contact the board card; and
a retaining body on which the first connection end of the first terminal is retained, a surface of one side of the first connection end of the first terminal is exposed from the retaining body to form a conductive contact suitable for electrical contact with the mating terminal, the retaining body forms a plug adapted for insertion into the mating connector.

2. The connector according to claim 1, wherein the retaining body is an injection molded part formed directly on the first connection end of the first terminal through an embedding injection molding process.

3. The connector according to claim 1, wherein:
the housing has opposite front and rear sides in its longitudinal direction, and a slot formed on the front side of the housing and adapted to receive the board card; and
the first contact end of the first terminal and the second contact end of the second terminal are located in the slot to make electrical contact with the board card inserted into the slot.

4. The connector according to claim 3, wherein the connector further includes:
multiple first terminals arranged in an upper row and a lower row, the upper row of first terminals and the lower row of first terminals are opposite in a height direction of the housing and proximate to one side of the housing in a transverse direction of the housing; and
multiple second terminals arranged in an upper row and a lower row, the upper row of second terminals and the lower row of second terminals are opposite in the height direction of the housing and proximate to the other side of the housing in the transverse direction of the housing, wherein:
the first contact ends of the upper row of first terminals and the second contact ends of the upper row of second terminals are arranged in a row at uniform intervals along the transverse direction of the housing; and
the first contact ends of the lower row of first terminals and the second contact ends of the lower row of second terminals are arranged in a row at uniform intervals along the transverse direction of the housing.

5. The connector according to claim 4, wherein:
the first connection ends of the upper row of first terminals are located outside the housing and arranged along a longitudinal direction of the housing;
the first connection ends of the lower row of first terminals are located outside the housing and arranged along the longitudinal direction of the housing;
the second connection ends of the upper row of second terminals are located inside the housing and arranged along the transverse direction of the housing; and
the second connection ends of the lower row of second terminals are located inside the housing and arranged along the transverse direction of the housing.

6. The connector according to claim 4, further comprising a first holding body adapted to hold the first terminal and the second terminal together, wherein:
the first holding body is an injection molded part directly formed on the first terminal and the second terminal through embedding injection molding process;
the first terminal has a connection part connected between the first contact end and the first connection end; and
the connection part extends out of the housing and is bent perpendicularly towards one transverse side of the housing relative to the longitudinal direction of the housing.

7. The connector according to claim 6, further comprising:
a cable, a core wire of which is electrically connected to the second connection end of the second terminal; and
a second holding body adapted to hold the connection part of the first terminal, the second connection end of the second terminal, and one end of the cable together, the second holding body is an injection molded part directly formed on the first terminal, the second terminal, and the cable through embedded injection molding process.

8. The connector according to claim 7, further comprising an external injection molded body formed on a rear side of the housing for combining the second holding body and the retaining body to the rear side of the housing and wrapping the connection part of the first terminal.

9. The connector according to claim 1, wherein the first terminal is a first signal terminal, the second terminal is a second signal terminal, and a signal transmission rate of the first signal terminal is lower than that of the second signal terminal.

10. A connector, comprising:
a housing;
a circuit board having a first contact and a second contact;
a first terminal arranged in the housing and having a first connection end for electrical contact with the first contact and a first contact end for electrical contact with a board card; and
a second terminal arranged in the housing and having a second connection end for electrical connection with a cable and a second contact end for electrical contact with the board card, the circuit board having a plug portion adapted for insertion into a mating connector, and the second contact is formed on the surface of the plug portion for electrical contact with a mating terminal in the mating connector.

11. The connector according to claim 10, wherein:
the housing has opposite front and rear sides in its longitudinal direction, a slot is formed on the front side of the housing for inserting the board card; and
the first contact end of the first terminal and the second contact end of the second terminal are located in the slot to make electrical contact with the board card inserted into the slot.

12. The connector according to claim 11, wherein:
the connector includes multiple first terminals arranged in an upper row and a lower row, the upper row of first terminals and the lower row of first terminals are opposite in a height direction of the housing and close to one side of the housing in a transverse direction of the housing;
the connector includes multiple second terminals arranged in an upper row and a lower row, the upper row of second terminals and the lower row of second terminals are opposite in the height direction of the housing and close to the other side of the housing in the transverse direction of the housing;
the first contact ends of the upper row of first terminals and the second contact ends of the upper row of second terminals are arranged in a row at uniform intervals along the transverse direction of the housing; and
the first contact ends of the lower row of first terminals and the second contact ends of the lower row of second terminals are arranged in a row at uniform intervals along the transverse direction of the housing.

13. The connector according to claim 12, further comprising multiple cables, core wires of which are electrically connected to the second connection ends of the multiple second terminals, respectively, wherein:
the multiple cables are arranged in an upper row and a lower row, the upper row of cables and the lower row of cables face each other in the height direction of the housing; and
a portion of the circuit board is inserted between the upper row of cables and the lower row of cables, so that the upper row of cables and the lower row of cables are separated by the circuit board.

14. The connector according to claim 12, wherein:
the first connection end of the first terminal is a curved elastic end, and one side of the circuit board is inserted between the first connection ends of the upper row of first terminals and the first connection ends of the lower row of first terminals; and
a row of the first contacts is formed on each of the front surface and the back surface of one side of the circuit board, the row of the first contacts on the front surface of the circuit board is in electrical contact with the first connection ends of the upper row of first terminals, and the row of the first contacts on the back surface of the circuit board is in electrical contact with the first connection ends of the lower row of the first terminals.

15. The connector according to claim 14, wherein:
the first connection ends of the upper row of first terminals are located outside of the housing and arranged along the transverse direction of the housing;
the first connection ends of the lower row of first terminals are located outside of the housing and arranged along the transverse direction of the housing;
the second connection ends of the upper row of second terminals are located inside the housing and arranged along the transverse direction of the housing; and
the second connection ends of the lower row of second terminals are located inside the housing and arranged along the transverse direction of the housing.

16. The connector according to claim 14, wherein:
a row of second contacts is formed on each of the front surface and the back surface of the plug portion of the circuit board; and
the first contacts on one side of the circuit board extend along the longitudinal direction of the housing, and the second contacts on the plug portion of the circuit board extend along the transverse direction of the housing.

17. The connector according to claim 12, further comprising a first holding body holding the first terminal and the second terminal together, such that the first terminal and the second terminal can be installed together in the housing, the first holding body is an injection molded part directly formed on the first terminal and the second terminal through embedding injection molding process.

18. The connector according to claim 17, further comprising:
a second holding body holding the first terminal, the second terminal, and the cable together, such that the first terminal, the second terminal, and the cable can be installed together in the housing; and
a third holding body holding the multiple first terminals together, wherein the second holding body is located between the first holding body and the third holding body, and the third holding body is close to the first connection end of the first terminal, wherein:
the second holding body is an injection molded part directly formed on the first terminal, the second terminal, and the cable through embedded injection molding process; and
the third holding body is an injection molded part directly formed on the first terminals through embedded injection molding process.

19. The connector according to claim 18, further comprising an external injection molded body formed on a rear side of the housing and adapted to bond the circuit board to the rear side of the housing and wrapping the first connection ends of the first terminals.

20. The connector according to claim 10, wherein the first terminal comprises a first signal terminal, the second terminal comprises a second signal terminal, and a signal transmission rate of the first signal terminal is lower than that of the second signal terminal.
